(19) United States
(12) Patent Application Publication
(10) Pub. No.: US 2025/0096955 A1
(43) Pub. Date: Mar. 20, 2025

(54) HYBRID AUTOMATIC REPEAT REQUEST FEEDBACK METHOD AND APPARATUS

(71) Applicants: Beijing Xiaomi Mobile Software Co., Ltd., BEIJING (CN); Beijing University of Posts and Telecommunications, Beijing (CN)

(72) Inventors: Yajun ZHU, Beijing (CN); Wei HONG, Beijing (CN); Xinyu MA, Beijing (CN); Yong LI, Beijing (CN)

(21) Appl. No.: 18/726,071

(22) PCT Filed: Jan. 5, 2022
(86) PCT No.: PCT/CN2022/070402

§ 371 Date: Jul. 1, 2024

(51) Int. Cl. H04L 1/1829; H04W 72/0453; H04W 72/21

(52) U.S. Cl. CPC H04L 1/1864; H04W 72/0453; H04W 72/21

(57) ABSTRACT

A method for feeding back a hybrid automatic repeat request (HARQ), includes: when a first HARQ feedback bit for first DCI and a second HARQ feedback bit for second DCI issued by a network device need to be carried on a same PUCCH format 0 sequence, user equipment processes the PUCCH format 0 sequence based on a pre-configured mode, and transmits a processed PUCCH format 0 sequence to the network device.

### CROSS-REFERENCE TO RELATED APPLICATIONS

The present application is a U.S. National Stage of International Application No. PCT/CN2022/070402, filed on Jan. 5, 2022, the contents of all of which are incorporated herein by reference in their entireties for all purposes.

### BACKGROUND OF THE INVENTION

With the development of the mobile communication technology, the third generation partnership project (3GPP) in version 17 supports a high-priority hybrid automatic repeat request (HARQ) feedback bit and a low-priority HARQ feedback bit to be multiplexed on the same physical uplink control channel (PUCCH) format 0 sequence.

### SUMMARY OF THE INVENTION

An example of a first aspect of the disclosure provides a method for feeding back an HARQ. The method is performed by user equipment (UE). The method includes: processing, on a condition that it is determined that a same physical uplink control channel (PUCCH) sequence has to carry an HARQ feedback codebook based on first downlink control information (DCI) and second DCI received from a network device, the PUCCH sequence carrying the HARQ feedback codebook based on a preconfigured mode, where the PUCCH sequence is a PUCCH format 0 sequence, and the HARQ feedback codebook includes a first HARQ feedback bit for the first DCI and a second HARQ feedback bit for the second DCI; and transmitting a processed PUCCH sequence to the network device.

An example of a second aspect of the disclosure provides a method for feeding back an HARQ. The method is performed by a network device. The method includes: transmitting first downlink control information (DCI) and second DCI, and receiving a physical uplink control channel (PUCCH) sequence fed back by user equipment (UE), where the first DCI and the second DCI indicate that a same PUCCH sequence carries an HARQ feedback codebook including a first HARQ feedback bit for the first DCI and a second HARQ feedback bit for the second DCI, and the PUCCH sequence fed back is a PUCCH format 0 sequence; determining a number of HARQ feedback bits included in the HARQ feedback codebook based on a preconfigured mode; and determining values of the HARQ feedback bits included in the HARQ feedback codebook and DCI corresponding to the HARQ feedback bits included in the HARQ feedback codebook based on the number of the HARQ feedback bits and the preconfigured mode.

An example of a third aspect of the disclosure provides a communication device. The communication device includes: a transceiver; a memory; and a processor connected to the transceiver and the memory separately, configured to control the transceiver to transceive radio signals by executing a computer-executable instruction on the memory, and capable of implementing the method for feeding back an HARQ according to the first aspect or the method for feeding back an HARQ according to the second aspect.

An example of a fourth aspect of the disclosure provides a computer storage medium. The computer storage medium stores a computer-executable instruction. The computer-executable instruction when executed by a processor, causes the processor to implement the method for feeding back an HARQ according to the first aspect or the method for feeding back an HARQ according to the second aspect.

Additional aspects and advantages of the disclosure will be set forth partially in the following description, which will become obvious in the following description, or can be learned by practice of the disclosure.

### BRIEF DESCRIPTION OF DRAWINGS

The above and/or additional aspects and advantages of the disclosure will become obvious and comprehensible from the description of examples in conjunction with the drawings.

FIG. 1 is a schematic diagram of a framework of a communication system according to an example of the disclosure;

FIG. 2 is a schematic diagram of a physical uplink control channel (PUCCH) format 0 sequence for carrying a hybrid automatic repeat request (HARQ) feedback codebook;

FIG. 3 is a schematic flow diagram of a method for feeding back an HARQ according to an example of the disclosure;

FIG. 4 is a schematic flow diagram of a method for feeding back an HARQ according to an example of the disclosure;

FIG. 5 is a schematic flow diagram of a method for feeding back an HARQ according to an example of the disclosure;

FIG. 6 is a schematic diagram of a PUCCH format 0 sequence for carrying an HARQ feedback codebook in different rotation modes according to an example of the disclosure;

FIG. 7 is a schematic flow diagram of a method for feeding back an HARQ according to an example of the disclosure;

FIG. 8 is a schematic flow diagram of a method for feeding back an HARQ according to an example of the disclosure;

FIG. 9 is a schematic flow diagram of a method for feeding back an HARQ according to an example of the disclosure;

FIG. 10 is a schematic flow diagram of a method for feeding back an HARQ according to an example of the disclosure;

FIG. 11 is a schematic flow diagram of a method for feeding back an HARQ according to an example of the disclosure;

FIG. 12 is a schematic flow diagram of a method for feeding back an HARQ according to an example of the disclosure;

FIG. 13 is a block diagram of an apparatus for feeding back an HARQ according to an example of the disclosure;

FIG. 14 is a block diagram of an apparatus for feeding back an HARQ according to an example of the disclosure;

FIG. 15 is a schematic structural diagram of a communication apparatus according to an example of the disclosure; and

FIG. 16 is a schematic structural diagram of a chip according to an example of the disclosure.

### DETAILED DESCRIPTION OF THE INVENTION

Examples of the disclosure will be described in detail below. Instances of the examples are shown in accompanying drawings, throughout which identical or similar reference numerals denote identical or similar elements or elements having identical or similar functions. The examples described with reference to the accompanying drawings are illustrative and only intended to explain the disclosure, instead of limiting the disclosure.

If downlink control information (DCI) is missed, reliability of identifying the high-priority HARQ feedback bit on the PUCCH format 0 sequence will be reduced. As for this, the disclosure provides a method and apparatus for feeding back a hybrid automatic repeat request (HARQ) relating to the technical field of mobile communication.

For better understanding of a method and apparatus for feeding back a hybrid automatic repeat request (HARQ) according to the examples of the disclosure, a communication system applicable to the examples of the disclosure will be described below.

With reference to FIG. 1, FIG. 1 is a schematic diagram of a framework of a communication system according to an example of the disclosure. The communication system may include, but is not limited to, a network device and user equipment. A number and a form of devices shown in FIG. 1 are only illustrative and do not limit the examples of the disclosure. In practical application, the communication system may include two or more network devices and two or more pieces of user equipment. For instance, the communication system shown in FIG. 1 may include a network device 101 and user equipment 102.

It should be noted that technical solutions of the examples of the disclosure may be applied to various communication systems, such as a long term evolution (LTE) system, a 5th generation (5G) mobile communication system, a 5G new radio (NR) system, or other novel mobile communication systems in the future.

The network device 101 in the example of the disclosure is an entity configured to transmit or receive a signal on a network side. For instance, the network device 101 may be an evolved NodeB (eNB), a transmission reception point (TRP), a next generation NodeB (gNB) in the NR system, a base station in other future mobile communication systems, or an access node in a wireless fidelity (WiFi) system. The example of the disclosure does not limit a specific technology and a specific device form used by the network device 101. The network device 101 according to the example of the disclosure may be composed of a central unit (CU) and a distributed unit (DU). The CU may also be referred to as a control unit. With a structure of CU-DU, protocol layers of the network device 101, for instance, a base station, may be separated. Functions of some protocol layers are centrally controlled by the CU while functions of the other or all protocol layers are distributed in the DU, and the DU is centrally controlled by the CU.

The user equipment 102 in the example of the disclosure is an entity, for instance, a mobile phone, configured to receive or transmit a signal on a user side. The user equipment (UE) 102 may also be referred to as a terminal, a mobile station (MS), a mobile terminal (MT), etc. The user equipment 102 may be a vehicle having a communication function, an intelligent vehicle, a mobile phone, a wearable device, a tablet personal computer (Pad), a computer having a radio transceiving function, a virtual reality (VR) terminal device, an augmented reality (AR) terminal device, a radio terminal device in industrial control, a radio terminal device in self-driving, a radio terminal device in remote medical surgery, a radio terminal device in smart grid, a radio terminal device in transportation safety, a radio terminal device in smart city, a radio terminal device in smart home, etc. The example of the disclosure does not limit a specific technology and a specific device form used by the user equipment 102.

It may be understood that the communication system described in the examples of the disclosure is intended to describe the technical solution of the examples of the disclosure more clearly, instead of limiting the technical solution according to the examples of the disclosure. Those of ordinary skill in the art may know that the technical solution according to the examples of the disclosure is also applicable to similar technical problems with evolution of a system structure and emergence of new business cases.

In a 5G application scene, ultra-reliable and low-latency communication (uRLLC) is characterized by high reliability and low latency, and has high availability in fields of virtual reality, telemedicine, autonomous driving, smart grid, etc., which provides a new breakthrough for combination of mobile communication and related industries.

A priority allocation and multiplexing mechanism of HARQ feedback is one of the key technologies of the URLLC. The mechanism distinguishes between enhanced mobile broadband (eMBB) and URLLC services, and specifies a transmission mode of the HARQ feedback for the two types of services. Under the mechanism, HARQ feedback of a high-priority service scheduled later and HARQ feedback of a low-priority service scheduled firstly may be transmitted on a same physical resource, such that the HARQ feedback of the high-priority service can be completed as soon as possible, and transmission latency can be reduced.

A physical uplink control channel (PUCCH) format 0 sequence is a PUCCH format type commonly used in the URLLC service. The PUCCH format 0 sequence is used to carry 1 bit-2 bits of uplink control information (UCI), which occupies less orthogonal frequency division multiplexing (OFDM) symbols and has short duration. Compared with a long PUCCH format sequence, the PUCCH format 0 sequence can better satisfy low-latency service requirements.

The third generation partnership project (3GPP) with version 17 supports multiplexing a high-priority hybrid automatic repeat request (HARQ) feedback bit and a low-priority HARQ feedback bit on a same PUCCH format 0 sequence.

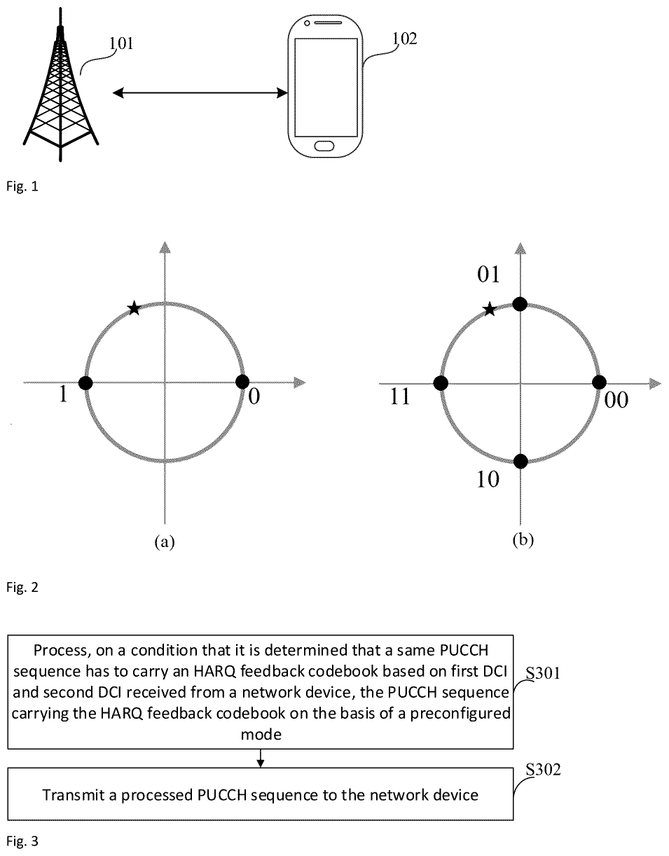

In this case, if downlink control information (DCI) is missed, reliability of feeding back an HARQ may be influenced. When a base station schedules HARQ feedback of a 1-bit high-priority service and HARQ feedback of a 1-bit low-priority service to be multiplexed on the PUCCH format 0 sequence, on a condition that DCI for scheduling the HARQ feedback of the low-priority service is missed by the UE, the base station and the UE may have ambiguity on a number of HARQ feedback bits on the PUCCH format 0 sequence. That is, the UE actually transmits the HARQ feedback of the 1-bit high-priority service, while the base station detects expected 2-bit HARQ feedback, such that a false detection rate of the HARQ feedback of the high-priority service is increased, and reliability is decreased. For instance, in a case that the HARQ feedback is multiplexed with the PUCCH format 0 sequence, a first bit in an HARQ feedback codebook is the HARQ feedback of the high-priority service, and a second bit is the HARQ feedback of the low-priority service. If the UE misses the DCI for scheduling the HARQ feedback of the low-priority service and only transmits the HARQ feedback “1” of the 1-bit high-priority service, the UE expects the base station to detect the 1-bit HARQ feedback according to a sequence shown in FIG. 2(a). However, as shown in FIG. 2(b), the base station may detect the 2-bit HARQ feedback, and determine that received feedback is “01”, such that the HARQ feedback of the high-priority service is falsely determined as 0, leading to retransmission of the high-priority service and causing latency. In FIGS. 2(a) and 2(b), black dots indicate expected phase positions of the PUCCH format 0 sequence that is not influenced by channel interference, that is, phase positions of the PUCCH format 0 sequence transmitted by the UE, and black stars indicate actual phase positions of the PUCCH format 0 sequence, that is, phase positions of the PUCCH format 0 sequence actually received by the base station. The PUCCH format 0 sequence carries the HARQ feedback bit. The phase position of the PUCCH format 0 sequence actually received by the base station deviates from the phase position of the PUCCH format 0 sequence transmitted by the UE because the phase position is influenced by channel fading and noise during transmission.

In view of this, the disclosure provides a method and apparatus for feeding back an HARQ, such that a high-priority HARQ feedback bit can be identified as reliably as possible in a case that DCI is missed, and no additional resource overhead can be generated. On a condition that it is determined that a same PUCCH format 0 sequence has to carry the first HARQ feedback bit for the first DCI and the second HARQ feedback bit for the second DCI that are transmitted by the network device, user equipment processes the PUCCH format 0 sequence based on the preconfigured mode; and the processed PUCCH format 0 sequence is transmitted to the network device. After receiving the PUCCH format 0 sequence, the network device analyzes the PUCCH format 0 sequence fed back based on the preconfigured mode, so as to determine the number of the HARQ feedback bits included in the HARQ feedback codebook carried by the PUCCH format 0 sequence fed back, and determines the values of the HARQ feedback bits included in the HARQ feedback codebook and the corresponding DCI based on the number of the HARQ feedback bits and the preconfigured mode. Thus, on a condition that the user equipment carries the first HARQ feedback bit for the first DCI and the second HARQ feedback bit for the second DCI that are transmitted by the network device on the same PUCCH format 0 sequence, the PUCCH format 0 sequence is processed based on the preconfigured mode and then transmitted to the network device. In this way, after the network device receives the PUCCH format 0 sequence, on a condition it is determined that the PUCCH format 0 sequence is processed based on the preconfigured mode, it may be determined that the PUCCH format 0 sequence is fed back by the user equipment in response to the first DCI and the second DCI transmitted. Otherwise, it may be determined that the PUCCH format 0 sequence is not fed back by the user equipment in response to the first DCI and the second DCI transmitted, that is, DCI is missed. Further, the network device may determine the DCI corresponding to the HARQ feedback bit carried by the PUCCH format 0 sequence. In this way, the high-priority HARQ feedback bit can be identified as reliably as possible in a case that the DCI is missed, and no additional resource overhead can be generated.

The method and apparatus for feeding back an HARQ according to the disclosure will be described in detail with reference to the accompanying drawings below.

FIG. 3 is a schematic flow diagram of a method for feeding back an HARQ according to an example of the disclosure. As shown in FIG. 3, the method may be performed by user equipment and include the following steps:

S301, on a condition that it is determined that a same PUCCH sequence has to carry an HARQ feedback codebook based on first DCI and second DCI received from a network device, the PUCCH sequence carrying the HARQ feedback codebook is processed based on a preconfigured mode.

The PUCCH sequence is a PUCCH format 0 sequence. The HARQ feedback codebook includes a first HARQ feedback bit for the first DCI and a second HARQ feedback bit for the second DCI.

On a condition that the user equipment detects the first DCI and the second DCI that are transmitted by the network device, the first DCI and the second DCI have different priorities (that is, the first DCI and the second DCI schedule downlink services having different priorities), and instruct the user equipment to conduct HARQ feedback on the same physical resource, it is indicated that DCI is not missed and the HARQ feedback has to be multiplexed. In this case, the user equipment processes the PUCCH format 0 sequence for carrying the HARQ feedback codebook based on the preconfigured mode, where the HARQ feedback codebook includes the first HARQ feedback bit for the first DCI and the second HARQ feedback bit for the second DCI. The HARQ feedback is multiplexed by carrying the HARQ feedback codebook on the same PUCCH format 0 sequence.

The preconfigured mode may be prespecified with a protocol, or may be configured by the network device through radio resource control (RRC) signaling.

S302, a processed PUCCH sequence is transmitted to the network device.

The user equipment transmits the processed PUCCH format 0 sequence to the network device.

In the example, after the network device transmits the first DCI and the second DCI to the user equipment and then receives the PUCCH format 0 sequence from the user equipment, whether the PUCCH format 0 sequence is processed based on the preconfigured mode may be determined. If yes, it is indicated that the user equipment does not miss DCI and multiplexes the HARQ feedback, that is, the PUCCH format 0 sequence carries the first HARQ feedback bit for the first DCI and the second HARQ feedback bit for the second DCI. If no, it is indicated that DCI is missed and the HARQ feedback is not multiplexed, that is, the PUCCH format 0 sequence only carries one HARQ feedback bit between the HARQ feedback bit for the first DCI and the HARQ feedback bit for the second DCI. The network device may further determine the DCI corresponding to the HARQ feedback bit carried by the PUCCH format 0 sequence.

According to the method for feeding back an HARQ of the example of the disclosure, on a condition that it is determined that a same PUCCH format 0 sequence has to carry the first HARQ feedback bit for the first DCI and the second HARQ feedback bit for the second DCI that are transmitted by the network device, the user equipment processes the PUCCH format 0 sequence based on the preconfigured mode; and the processed PUCCH format 0 sequence is transmitted to the network device. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

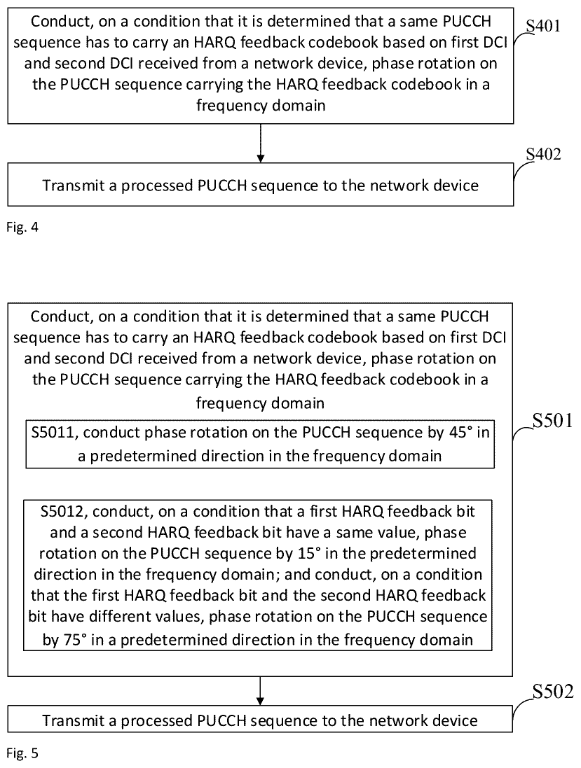

FIG. 4 is a schematic flow diagram of a method for feeding back an HARQ according to an example of the disclosure. As shown in FIG. 4, the method may be performed by user equipment and include the following steps:

S401, on a condition that it is determined that a same PUCCH sequence has to carry an HARQ feedback codebook based on first DCI and second DCI received from a network device, phase rotation is conducted on the PUCCH sequence carrying the HARQ feedback codebook in a frequency domain.

The PUCCH sequence is a PUCCH format 0 sequence. The HARQ feedback codebook includes a first HARQ feedback bit for the first DCI and a second HARQ feedback bit for the second DCI.

In the example, a preconfigured mode may include a rotation mode. The PUCCH sequence carrying the HARQ feedback codebook may be processed based on the preconfigured mode as follows: phase rotation is conducted on the PUCCH sequence in the frequency domain.

In the example, on a condition that the user equipment detects the first DCI and the second DCI that are transmitted by the network device, the first DCI and the second DCI instruct the user equipment to conduct HARQ feedback on the same physical resource, which indicates that DCI is not missed, and the HARQ feedback has to be multiplexed. In this case, the user equipment conducts phase rotation on the PUCCH format 0 sequence for carrying the HARQ feedback codebook, where the HARQ feedback codebook includes the first HARQ feedback bit for the first DCI and the second HARQ feedback bit for the second DCI. The HARQ feedback is multiplexed by carrying the HARQ feedback codebook on the same PUCCH format 0 sequence.

The rotation mode may be prespecified with a protocol, or may be configured by the network device through radio resource control (RRC) signaling.

S402, the processed PUCCH sequence is transmitted to the network device.

The user equipment transmits the PUCCH format 0 sequence subjected to phase rotation to the network device.

In the example, after the network device transmits the first DCI and the second DCI to the user equipment and then receives the PUCCH format 0 sequence from the user equipment, whether the PUCCH format 0 sequence is subjected to phase rotation may be determined. If yes, it is indicated that the user equipment does not miss DCI and multiplexes the HARQ feedback, that is, the PUCCH format 0 sequence carries the first HARQ feedback bit for the first DCI and the second HARQ feedback bit for the second DCI. If no, it is indicated that DCI is missed and the HARQ feedback is not multiplexed, that is, the PUCCH format 0 sequence only carries the HARQ feedback bit for one of the first DCI and the second DCI. The network device may further determine the DCI corresponding to the HARQ feedback bit carried by the PUCCH format 0 sequence.

According to the method for feeding back an HARQ of the example of the disclosure, on a condition that it is determined that a same PUCCH format 0 sequence has to carry the first HARQ feedback bit for the first DCI and the second HARQ feedback bit for the second DCI that are transmitted by the network device, the user equipment conducts phase rotation on the PUCCH format 0 sequence; and the PUCCH format 0 sequence subjected to phase rotation is transmitted to the network device. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

FIG. 5 is a schematic flow diagram of a method for feeding back an HARQ according to an example of the disclosure. As shown in FIG. 5, the method may be performed by user equipment and include the following steps:

S501, on a condition that it is determined that a same PUCCH sequence has to carry an HARQ feedback codebook based on first DCI and second DCI received from a network device, phase rotation is conducted on the PUCCH sequence carrying the HARQ feedback codebook in a frequency domain.

The PUCCH sequence is a PUCCH format 0 sequence. The HARQ feedback codebook includes a first HARQ feedback bit for the first DCI and a second HARQ feedback bit for the second DCI.

In some examples, S501 may include any one of the following steps:

S5011, phase rotation is conducted on the PUCCH sequence by 45° in a predetermined direction in the frequency domain.

In S5011, on a condition that the first HARQ feedback bit and the second HARQ feedback bit have a same value, phase rotation is conducted on the PUCCH sequence by 15° in the predetermined direction in the frequency domain; and on a condition that the first HARQ feedback bit and the second HARQ feedback bit have different values, phase rotation is conducted on the PUCCH sequence by 75° in a predetermined direction in the frequency domain.

In the example, on a condition that the user equipment detects the first DCI and the second DCI that are transmitted by the network device, the first DCI and the second DCI instruct the user equipment to conduct HARQ feedback on the same physical resource, which indicates that DCI is not missed, and the HARQ feedback has to be multiplexed. In this case, the user equipment conducts phase rotation on the PUCCH format 0 sequence for carrying the HARQ feedback codebook, where the HARQ feedback codebook includes the first HARQ feedback bit for the first DCI and the second HARQ feedback bit for the second DCI. The HARQ feedback is multiplexed by carrying the HARQ feedback codebook on the same PUCCH format 0 sequence.

In some examples, on a condition that a priority of the first HARQ feedback bit is higher than that of the second HARQ feedback bit, the predetermined direction is a clockwise direction. On a condition that the priority of the first HARQ feedback bit is lower than that of the second HARQ feedback bit, the predetermined direction is an anticlockwise direction. The first HARQ feedback bit is a first bit in the HARQ feedback codebook, and the second HARQ feedback bit is a second bit in the HARQ feedback codebook.

For phase rotation of the PUCCH format 0 sequence, any one of the following rotation modes may be used.

A first rotation mode: rotation is conducted on the PUCCH format 0 sequence by 45° in the predetermined direction in the frequency domain.

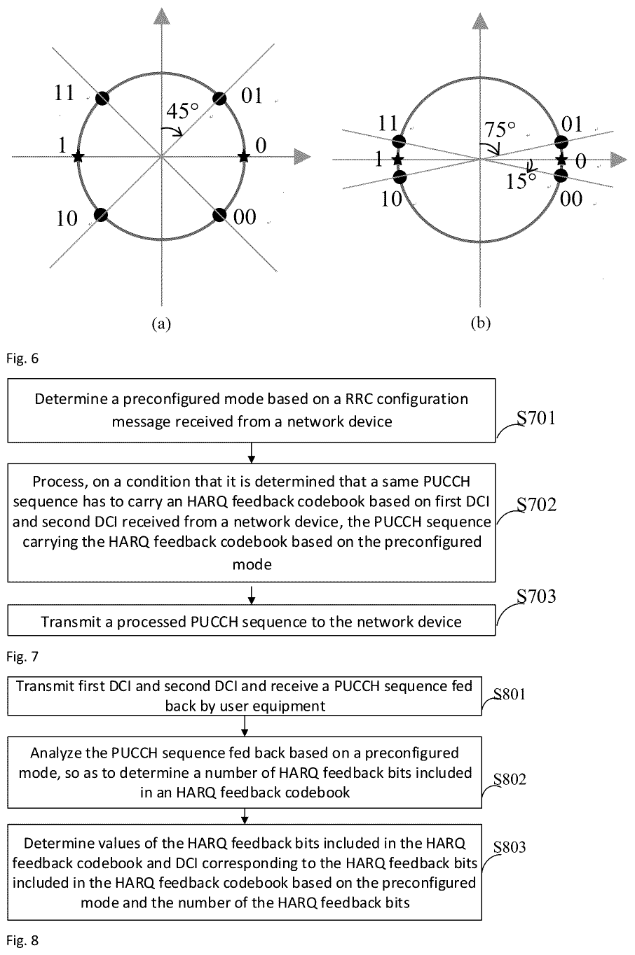

FIG. 6(a) shows a rotated PUCCH format 0 sequence in the rotation mode, where black dots indicate expected phase positions of the PUCCH format 0 sequence, for carrying the HARQ feedback bit, rotated by 45° and not influenced by channel interference, and black stars indicate actual phase positions of the PUCCH format 0 sequence. As shown in FIG. 6(a), if a first HARQ feedback bit in the HARQ feedback codebook is an HARQ feedback bit of a high-priority service and a second HARQ feedback bit is an HARQ feedback bit of a low-priority service, the PUCCH format 0 sequences corresponding to the HARQ feedback codebooks “00”, “11”, “01” and “10” are rotated clockwise by 45°. Accordingly, if a first HARQ feedback bit in the HARQ feedback codebook is an HARQ feedback bit of a low-priority service and a second HARQ feedback bit is an HARQ feedback bit of a high-priority service, the PUCCH format 0 sequences corresponding to the HARQ feedback codebooks “00”, “11”, “01” and “10” are rotated anticlockwise by 45°, which are not shown in FIG. 6(a).

After the PUCCH format 0 sequence is rotated in the rotation mode, the network device has a same false determination rate for the HARQ feedback bit of the high-priority service and the HARQ feedback bit of the low-priority service, such that reliability of HARQ feedback of the high-priority service can be improved.

A second rotation mode: on a condition that the first HARQ feedback bit and the second HARQ feedback bit have a same value, phase rotation is conducted on the PUCCH format 0 sequence by 15° in the predetermined direction in the frequency domain; and on a condition that the first HARQ feedback bit and the second HARQ feedback bit have different values, phase rotation is conducted on the PUCCH format 0 sequence by 75° in a predetermined direction in the frequency domain.

FIG. 6(b) shows a rotated PUCCH format 0 sequence in the rotation mode, where black dots indicate expected phase positions of the PUCCH format 0 sequence, for carrying the HARQ feedback bit, rotated by 15° or 75° and not influenced by channel interference, and black stars indicate actual phase positions of the PUCCH format 0 sequence. As shown in FIG. 6(b), if a first HARQ feedback bit in the HARQ feedback codebook is an HARQ feedback bit of a high-priority service and a second HARQ feedback bit is an HARQ feedback bit of a low-priority service, the PUCCH format 0 sequences corresponding to the HARQ feedback codebooks “00” and “11” are rotated clockwise by 15°, and the PUCCH format 0 sequences corresponding to the HARQ feedback codebooks “01” and “10” are rotated clockwise by 75°. Accordingly, if a first HARQ feedback bit in the HARQ feedback codebook is an HARQ feedback bit of a low-priority service and a second HARQ feedback bit is an HARQ feedback bit of a high-priority service, the PUCCH format 0 sequences corresponding to the HARQ feedback codebooks “00” and “11” are rotated anticlockwise by 15°, and the PUCCH format 0 sequences corresponding to the HARQ feedback codebooks “01” and “10” are rotated anticlockwise by 75°, which are not shown in FIG. 6(b).

After the PUCCH format 0 sequence is rotated in the rotation mode, a false determination rate for the HARQ feedback bit of the high-priority service by the network device is further decreased, and accordingly, a false determination rate for the HARQ feedback bit of the low-priority service is increased. That is, at the expense of decreasing reliability of HARQ feedback of the low-priority service, reliability of HARQ feedback of the high-priority service can be improved.

S502, the processed PUCCH sequence is transmitted to the network device.

Reference may be made to description of S302 and S402 and related details for detailed description of S502 and related details, which will not be repeated here.

According to the method for feeding back an HARQ of the example of the disclosure, on a condition that it is determined that a same PUCCH format 0 sequence has to carry the first HARQ feedback bit for the first DCI and the second HARQ feedback bit for the second DCI that are transmitted by the network device, the user equipment conducts phase rotation on the PUCCH format 0 sequence; and the PUCCH format 0 sequence subjected to phase rotation is transmitted to the network device. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

FIG. 7 is a schematic flow diagram of a method for feeding back an HARQ according to an example of the disclosure. As shown in FIG. 7, the method may be performed by user equipment and include the following steps:

S701, a preconfigured mode is determined bases on a RRC configuration message received from a network device.

In the example, the preconfigured mode may be configured by the network device through RRC signaling. The network device may preconfigure a mode for processing a PUCCH format 0 sequence for the user equipment through the RRC signaling according to actual needs in a case that HARQ feedback has to be multiplexed.

S702, on a condition that it is determined that a same PUCCH sequence has to carry an HARQ feedback codebook based on first DCI and second DCI received from the network device, the PUCCH sequence carrying the HARQ feedback codebook is processed based on the preconfigured mode, where the PUCCH sequence is the PUCCH format 0 sequence, and the HARQ feedback codebook includes a first HARQ feedback bit for the first DCI and a second HARQ feedback bit for the second DCI.

Reference may be made to description of S301-S501 and related details for detailed description of S702 and related details, which will not be repeated here.

S703, the processed PUCCH sequence is transmitted to the network device.

Reference may be made to description of S302-S502 and related details for detailed description of S703 and related details, which will not be repeated here.

According to the method for feeding back an HARQ of the example of the disclosure, on a condition that it is determined that a same PUCCH format 0 sequence has to carry the first HARQ feedback bit for the first DCI and the second HARQ feedback bit for the second DCI that are transmitted by the network device, the user equipment processes the PUCCH format 0 sequence based on the preconfigured mode; and the processed PUCCH format 0 sequence is transmitted to the network device. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

FIG. 8 is a schematic flow diagram of a method for feeding back an HARQ according to an example of the disclosure. As shown in FIG. 8, the method may be performed by a network device and include the following steps:

S801, first DCI and second DCI are transmitted, and a PUCCH sequence fed back by user equipment is received.

The first DCI and the second DCI indicate that a same PUCCH sequence carries an HARQ feedback codebook including a first HARQ feedback bit for the first DCI and a second HARQ feedback bit for the second DCI. The PUCCH sequence fed back is a PUCCH format 0 sequence.

The network device transmits the first DCI and the second DCI to the user equipment. The first DCI and the second DCI have different priorities (that is, the first DCI and the second DCI schedule downlink services having different priorities), and instruct the user equipment to conduct HARQ feedback on the same physical resource. Then, the network device expects to receive the PUCCH format 0 sequence carrying the HARQ feedback bit for the first DCI and the HARQ feedback bit for the second DCI from the user equipment.

S802, the PUCCH sequence fed back is analyzed based on a preconfigured mode, so as to determine a number of HARQ feedback bits included in the HARQ feedback codebook.

The preconfigured mode may be prespecified with a protocol, or may be configured by the network device through radio resource control (RRC) signaling.

After receiving the PUCCH format 0 sequence from the user equipment, the network device may analyze the PUCCH format 0 sequence based on the preconfigured mode, so as to determine the number of the HARQ feedback bits included in the HARQ feedback codebook carried by the PUCCH format 0 sequence, such that whether the PUCCH format 0 sequence is processed based on the preconfigured mode is determined. If yes, it is indicated that the user equipment does not miss DCI and multiplexes the HARQ feedback, that is, the PUCCH format 0 sequence carries the first HARQ feedback bit for the first DCI and the second HARQ feedback bit for the second DCI. If no, it is indicated that DCI is missed and the HARQ feedback is not multiplexed, that is, the PUCCH format 0 sequence only carries the HARQ feedback bit for one of the first DCI and the second DCI.

In some examples, the preconfigured mode includes a rotation mode. The rotation mode instructs the UE to conduct phase rotation on the PUCCH sequence carrying the HARQ feedback codebook in a frequency domain.

The preconfigured mode may be the rotation mode. The network device may determine whether the PUCCH format 0 sequence received from the user equipment is subjected to phase rotation.

In some examples, the rotation mode includes a first rotation mode. The first rotation mode instructs the UE to conduct phase rotation on the PUCCH sequence carrying the HARQ feedback codebook by 45° in a predetermined direction in the frequency domain.

On a condition that a priority of the first HARQ feedback bit is higher than a priority of the second HARQ feedback bit, the predetermined direction is a clockwise direction. On a condition that a priority of the first HARQ feedback bit is lower than a priority of the second HARQ feedback bit, the predetermined direction is an anticlockwise direction. The first HARQ feedback bit is a first bit in the HARQ feedback codebook, and the second HARQ feedback bit is a second bit in the HARQ feedback codebook.

Further, with reference to FIG. 6(a), FIG. 6(a) shows a rotated PUCCH format 0 sequence in the rotation mode, where black dots indicate expected phase positions of the PUCCH format 0 sequence, for carrying the HARQ feedback bit, rotated by 45° and not influenced by channel interference, and black stars indicate actual phase positions of the PUCCH format 0 sequence. As shown in FIG. 6(a), if a first HARQ feedback bit in the HARQ feedback codebook is an HARQ feedback bit of a high-priority service and a second HARQ feedback bit is an HARQ feedback bit of a low-priority service, the PUCCH format 0 sequences corresponding to the HARQ feedback codebooks “00”, “11”, “01” and “10” are rotated clockwise by 45°. Accordingly, if a first HARQ feedback bit in the HARQ feedback codebook is an HARQ feedback bit of a low-priority service and a second HARQ feedback bit is an HARQ feedback bit of a high-priority service, the PUCCH format 0 sequences corresponding to the HARQ feedback codebooks “00”, “11”, “01” and “10” are rotated anticlockwise by 45°, which are not shown in FIG. 6(a).

After the PUCCH format 0 sequence is rotated in the rotation mode, the network device has a same false determination rate for the HARQ feedback bit of the high-priority service and the HARQ feedback bit of the low-priority service, such that a false determination rate for the HARQ feedback bit of the high-priority service can be reduced.

In some examples, the rotation mode includes a second rotation mode. The second rotation mode instructs the UE to conduct, on a condition that the first HARQ feedback bit and the second HARQ feedback bit have a same value, phase rotation on the PUCCH sequence carrying the HARQ feedback codebook by 15° in a predetermined direction in the frequency domain, and to conduct, on a condition that the first HARQ feedback bit and the second HARQ feedback bit have different values, phase rotation on the PUCCH sequence carrying the HARQ feedback codebook by 75° in a predetermined direction in the frequency domain.

On a condition that a priority of the first HARQ feedback bit is higher than that of the second HARQ feedback bit, the predetermined direction is a clockwise direction. On a condition that the priority of the first HARQ feedback bit is lower than that of the second HARQ feedback bit, the predetermined direction is an anticlockwise direction. The first HARQ feedback bit is a first bit in the HARQ feedback codebook, and the second HARQ feedback bit is a second bit in the HARQ feedback codebook.

Further, with reference to FIG. 6(b), FIG. 6(b) shows a rotated PUCCH format 0 sequence in the rotation mode, where black dots indicate expected phase positions of the PUCCH format 0 sequence, for carrying the HARQ feedback bit, rotated by 15° or 75° and not influenced by channel interference, and black stars indicate actual phase positions of the PUCCH format 0 sequence. As shown in FIG. 6(b), if a first HARQ feedback bit in the HARQ feedback codebook is an HARQ feedback bit of a high-priority service and a second HARQ feedback bit is an HARQ feedback bit of a low-priority service, the PUCCH format 0 sequences corresponding to the HARQ feedback codebooks “00” and “11” are rotated clockwise by 15°, and the PUCCH format 0 sequences corresponding to the HARQ feedback codebooks “01” and “10” are rotated clockwise by 75°. Accordingly, if a first HARQ feedback bit in the HARQ feedback codebook is an HARQ feedback bit of a low-priority service and a second HARQ feedback bit is an HARQ feedback bit of a high-priority service, the PUCCH format 0 sequences corresponding to the HARQ feedback codebooks “00” and “11” are rotated anticlockwise by 15°, and the PUCCH format 0 sequences corresponding to the HARQ feedback codebooks “01” and “10” are rotated anticlockwise by 75°, which are not shown in FIG. 6(b).

After the PUCCH format 0 sequence is rotated in the rotation mode, a false determination rate for the HARQ feedback bit of the high-priority service by the network device is further decreased, and accordingly, a false determination rate for the HARQ feedback bit of the low-priority service is increased. That is, at the expense of decreasing reliability of HARQ feedback of the low-priority service, reliability of HARQ feedback of the high-priority service can be improved.

S803, values of the HARQ feedback bits included in the HARQ feedback codebook and DCI corresponding to the HARQ feedback bits included in the HARQ feedback codebook are determined based on the preconfigured mode and the number of the HARQ feedback bits.

After determining the number of the HARQ feedback bits included in the HARQ feedback codebook carried by the PUCCH format 0 sequence received, the network device may further determine DCI corresponding to the HARQ feedback bit included in the HARQ feedback codebook based on the preconfigured mode and the number of the HARQ feedback bits.

According to the method for feeding back an HARQ of the example of the disclosure, after receiving the PUCCH format 0 sequence, the network device analyzes the PUCCH format 0 sequence fed back based on the preconfigured mode, so as to determine the number of the HARQ feedback bits included in the HARQ feedback codebook carried by the PUCCH format 0 sequence fed back, and determines the values of the HARQ feedback bits included in the HARQ feedback codebook and the corresponding DCI based on the number of the HARQ feedback bits and the preconfigured mode. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

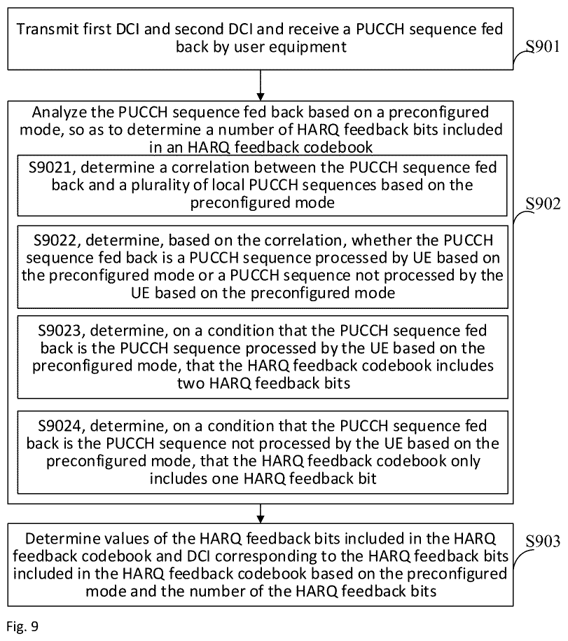

FIG. 9 is a schematic flow diagram of a method for feeding back an HARQ according to an example of the disclosure. As shown in FIG. 9, the method may be performed by a network device and include the following steps:

S901, first DCI and second DCI are transmitted, and a PUCCH sequence fed back by user equipment is received.

The first DCI and the second DCI indicate that a same PUCCH sequence carries an HARQ feedback codebook including a first HARQ feedback bit for the first DCI and a second HARQ feedback bit for the second DCI. The PUCCH sequence fed back is a PUCCH format 0 sequence.

Reference may be made to description of S801 and related details for detailed description of S901 and related details, which will not be repeated here.

S902, the PUCCH sequence fed back is analyzed based on a preconfigured mode, so as to determine a number of HARQ feedback bits included in the HARQ feedback codebook.

Reference may be made to description of S802 and related details for detailed description of S902 and related details, which will not be repeated here.

In addition, in some examples, S902 may be implemented through the following steps:

S9021, a correlation between the PUCCH sequence fed back and a plurality of local PUCCH sequences is determined based on the preconfigured mode. The plurality of local PUCCH sequences include all possible first local PUCCH sequences corresponding to two HARQ feedback bits and a plurality of second local PUCCH sequences obtained by separately processing the plurality of first local PUCCH sequences based on the preconfigured mode. Each local PUCCH sequence is a PUCCH format 0 sequence.

After receiving the PUCCH format 0 sequence from the user equipment, the network device may analyze a correlation between the PUCCH format 0 sequence and a local PUCCH format 0 sequence.

Specifically, the network device may pregenerate all possible first local PUCCH format 0 sequences corresponding to the two HARQ feedback bits, which, for instance, include four first local PUCCH format 0 sequences corresponding to HARQ feedback codebooks “00”, “11”, “01” and “10” respectively; and process the plurality of first local PUCCH format 0 sequences based on the preconfigured mode, so as to obtain a plurality of second local PUCCH format 0 sequences, and, for instance, process the four first local PUCCH format 0 sequences corresponding to the HARQ feedback codebooks “00”, “11”, “01” and “10” respectively, so as to obtain four processed second local PUCCH format 0 sequences corresponding to the HARQ feedback codebooks “00”, “11”, “01” and “10” respectively. After receiving the PUCCH format 0 sequence from the user equipment, the network device analyzes a correlation between the PUCCH format 0 sequence received and the above-mentioned eight local PUCCH format 0 sequences, such that a correlation between the PUCCH format 0 sequence received and each local PUCCH format 0 sequence is determined.

S9022, based on the correlation, whether the PUCCH sequence fed back is a PUCCH sequence processed by the UE based on the preconfigured mode or a PUCCH sequence not processed by the UE based on the preconfigured mode is determined.

After determining the correlation between the PUCCH format 0 sequence received and each local PUCCH format 0 sequence, the network device may determine whether the PUCCH format 0 sequence received is the PUCCH sequence processed based on the preconfigured mode according to the correlation.

Optionally, the correlation between the PUCCH sequence fed back and each local PUCCH sequence is determined with a standard of a correlation peak and/or a peak-to-average ratio.

A maximum value of correlation values between the PUCCH format 0 sequence fed back and four first local PUCCH format 0 sequences may be regarded as a correlation peak of the PUCCH format 0 sequence fed back and the first local PUCCH format 0 sequence. Similarly, a maximum value of correlation values between the PUCCH format 0 sequence fed back and four second local PUCCH format 0 sequences may be regarded as a correlation peak of the PUCCH format 0 sequence fed back and the second local PUCCH format 0 sequence.

A ratio between the correlation peak of the PUCCH format 0 sequence fed back and the first local PUCCH format 0 sequence and the average value of the correlation values of the PUCCH format 0 sequence fed back and the four first local PUCCH format 0 sequences may be regarded as a peak-to-average ratio of the PUCCH format 0 sequence fed back to the first local PUCCH format 0 sequence. Similarly, a ratio between the correlation peak of the PUCCH format 0 sequence fed back and the second local PUCCH format 0 sequence and the average value of the correlation values of the PUCCH format 0 sequence fed back and the four second local PUCCH format 0 sequences may be regarded as a peak-to-average ratio of the PUCCH format 0 sequence fed back to the second local PUCCH format 0 sequence.

For instance, on a condition that the correlation peak between the PUCCH format 0 sequence received and the first local format 0 sequence is greater than that between the PUCCH format 0 sequence received and the second local PUCCH format 0 sequence, it is indicated that the PUCCH format 0 sequence received is the PUCCH sequence not processed based on the preconfigured mode. Otherwise, it is indicated that the PUCCH format 0 sequence received is the PUCCH sequence processed based on the preconfigured mode.

For instance, on a condition that the peak-to-average ratio of the PUCCH format 0 sequence received to the first local format 0 sequence is greater than that of the PUCCH format 0 sequence received to the second local PUCCH format 0 sequence, it is indicated that the PUCCH format 0 sequence received is the PUCCH sequence not processed based on the preconfigured mode. Otherwise, it is indicated that the PUCCH format 0 sequence received is the PUCCH sequence processed based on the preconfigured mode.

For instance, on a condition that a product of the correlation peak and the peak-to-average ratio of the PUCCH format 0 sequence received and the first local format 0 sequence is greater than that of the correlation peak and the peak-to-average ratio of the PUCCH format 0 sequence received and the second local format 0 sequence, it is indicated that the PUCCH format 0 sequence received is the PUCCH sequence not processed based on the preconfigured mode. Otherwise, it is indicated that the PUCCH format 0 sequence received is the PUCCH sequence processed based on the preconfigured mode.

S9023, on a condition that the PUCCH sequence fed back is the PUCCH sequence processed by the UE based on the preconfigured mode, it is determined that the HARQ feedback codebook includes two HARQ feedback bits.

S9024, on a condition that the PUCCH sequence fed back is the PUCCH sequence not processed by the UE based on the preconfigured mode, it is determined that the HARQ feedback codebook only includes one HARQ feedback bit.

On a condition that the PUCCH format 0 sequence received is the PUCCH sequence processed based on the preconfigured mode, the network device may determine that the user equipment does not miss the DCI and multiplexes the HARQ feedback. In this way, it may be determined that the HARQ feedback codebook carried by the PUCCH format 0 sequence received includes two HARQ feedback bits. On a condition that the PUCCH format 0 sequence received is the PUCCH sequence not processed by the UE based on the preconfigured mode, the network device may determine that DCI is missed the and the user equipment does not multiplex the HARQ feedback. In this way, it may be determined that the HARQ feedback codebook carried by the PUCCH format 0 sequence received includes only one HARQ feedback bit.

S903, values of the HARQ feedback bits included in the HARQ feedback codebook and DCI corresponding to the HARQ feedback bits included in the HARQ feedback codebook are determined based on the preconfigured mode and the number of the HARQ feedback bits.

Reference may be made to description of S803 and related details for detailed description of S903 and related details, which will not be repeated here.

According to the method for feeding back an HARQ of the example of the disclosure, after receiving the PUCCH format 0 sequence, the network device analyzes the PUCCH format 0 sequence fed back based on the preconfigured mode, so as to determine the number of the HARQ feedback bits included in the HARQ feedback codebook carried by the PUCCH format 0 sequence fed back, and determines the values of the HARQ feedback bits included in the HARQ feedback codebook and the corresponding DCI based on the number of the HARQ feedback bits and the preconfigured mode. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

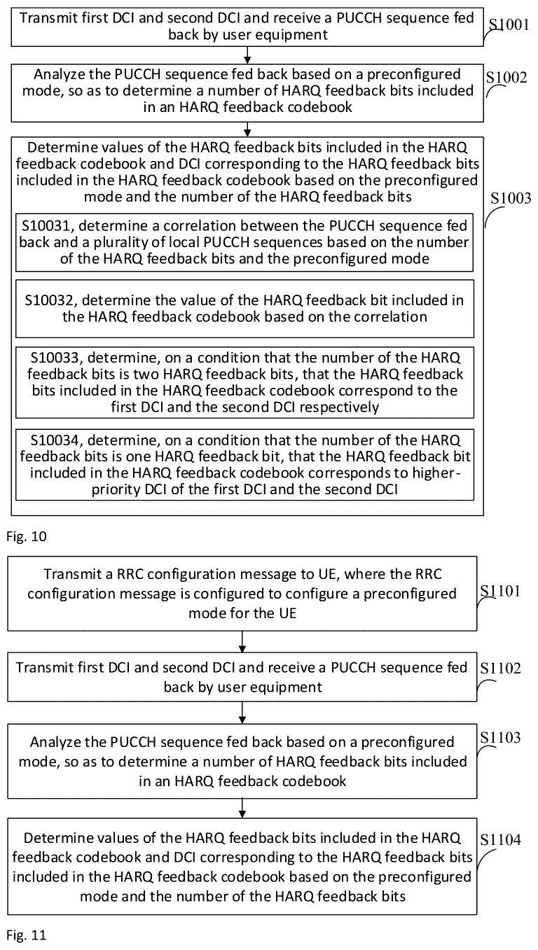

FIG. 10 is a schematic flow diagram of a method for feeding back an HARQ according to an example of the disclosure. As shown in FIG. 10, the method may be performed by a network device, and includes the following steps:

S1001, first DCI and second DCI are transmitted, and a PUCCH sequence fed back by user equipment is received.

The first DCI and the second DCI indicate that a same PUCCH sequence carries an HARQ feedback codebook including a first HARQ feedback bit for the first DCI and a second HARQ feedback bit for the second DCI. The PUCCH sequence fed back is a PUCCH format 0 sequence.

Reference may be made to description of S801-S901 and related details for detailed description of S1001 and related details, which will not be repeated here.

S1002, the PUCCH sequence fed back is analyzed based on a preconfigured mode, so as to determine a number of HARQ feedback bits included in the HARQ feedback codebook.

Reference may be made to description of S802-S902 and related details for detailed description of S1002 and related details, which will not be repeated here.

S1003, values of the HARQ feedback bits included in the HARQ feedback codebook and DCI corresponding to the HARQ feedback bits included in the HARQ feedback codebook are determined based on the preconfigured mode and the number of the HARQ feedback bits.

Reference may be made to description of S803-S903 and related details for detailed description of S1003 and related details, which will not be repeated here.

In addition, in some examples, S1003 may be implemented through the following steps:

S10031, a correlation between the PUCCH sequence fed back and a plurality of local PUCCH sequences is determined based on the number of the HARQ feedback bits and the preconfigured mode. On a condition that the number of the HARQ feedback bits is two HARQ feedback bits, the plurality of local PUCCH sequences include a plurality of second local PUCCH sequences obtained by separately processing all possible first local PUCCH sequences corresponding to the two HARQ feedback bits based on the preconfigured mode. On a condition that the number of the HARQ feedback bits is one HARQ feedback bit, the plurality of local PUCCH sequences include all possible third local PUCCH sequences corresponding to the one HARQ feedback bit, and each local PUCCH sequence is a PUCCH format 0 sequence.

After determining the number of the HARQ feedback bits included in the HARQ feedback codebook carried by the PUCCH format 0 sequence received, the network device may analyze a correlation between the PUCCH format 0 sequence and the local PUCCH format 0 sequence.

Specifically, the network device may pregenerate all possible first local PUCCH format 0 sequences corresponding to the two HARQ feedback bits, which, for instance, include four first local PUCCH format 0 sequences corresponding to HARQ feedback codebooks “00”, “11”, “01” and “10” respectively; process the plurality of first local PUCCH format 0 sequences based on the preconfigured mode, so as to obtain a plurality of second local PUCCH format 0 sequences, and, for instance, process the four first local PUCCH format 0 sequences corresponding to the HARQ feedback codebooks “00”, “11”, “01” and “10” respectively, so as to obtain four processed second local PUCCH format 0 sequences corresponding to the HARQ feedback codebooks “00”, “11”, “01” and “10” respectively; and generate all possible third local PUCCH format 0 sequences corresponding to one HARQ feedback bit, which for instance, include two third local PUCCH format 0 sequences corresponding to HARQ feedback codebooks “0” and “1” respectively.

After determining two HARQ feedback bits, the network device analyzes correlations between the PUCCH format 0 sequence received and the above-mentioned four second local PUCCH format 0 sequences, such that a correlation between the PUCCH format 0 sequence received and each second local PUCCH format 0 sequence is determined.

After determining one HARQ feedback bit, the network device analyzes correlations between the PUCCH format 0 sequence received and the above-mentioned two third local PUCCH format 0 sequences, such that a correlation between the PUCCH format 0 sequence received and each third local PUCCH format 0 sequence is determined.

S10032, the value of the HARQ feedback bit included in the HARQ feedback codebook is determined based on the correlation.

After determining the correlation between the PUCCH format 0 sequence received and the corresponding local PUCCH format 0 sequence, the network device may determine the value of the HARQ feedback bit included in the HARQ feedback codebook carried by the PUCCH format 0 sequence received according to the correlation.

Optionally, the correlation between the PUCCH sequence fed back and each local PUCCH sequence is determined with a standard of a correlation peak.

For instance, on a condition that the PUCCH format 0 sequence received has a highest correlation with a second local PUCCH format 0 sequence, that is, a correlation value between the PUCCH format 0 sequence received and the second local PUCCH format 0 sequence is the correlation peak of the PUCCH format 0 sequence received and the second local PUCCH format 0 sequence, and the second local PUCCH format 0 sequence is a second local PUCCH format 0 sequence corresponding to the HARQ feedback codebook “00”, it is indicated that the HARQ feedback codebook carried by the PUCCH format 0 sequence received is “00”. On a condition that the PUCCH format 0 sequence received has a highest correlation with a third local PUCCH format 0 sequence, and the third local PUCCH format 0 sequence is a third local PUCCH format 0 sequence corresponding to the HARQ feedback codebook “1”, it is indicated that the HARQ feedback codebook carried by the PUCCH format 0 sequence received is “1”.

S10033, on a condition that the number of the HARQ feedback bits is two HARQ feedback bits, it is determined that the HARQ feedback bits included in the HARQ feedback codebook correspond to the first DCI and the second DCI respectively.

When the network device determines that the number of the HARQ feedback bits is two HARQ feedback bits, it is determined that the HARQ feedback bits included in the HARQ feedback codebook carried by the PUCCH format 0 sequence received correspond to the first DCI and the second DCI respectively. A correspondence between the two HARQ feedback bits on the HARQ feedback codebook and the two pieces of DCI transmitted by the network device may be pre-agreed by the network device and the UE. For instance, the network device and the UE may pre-agree that a first HARQ feedback bit on the HARQ feedback codebook corresponds to the DCI transmitted by the network device firstly, and a second HARQ feedback bit on the HARQ feedback codebook corresponds to the DCI transmitted by the network device later. Generally, the DCI transmitted by the network device firstly has a low priority, that is, schedules a low-priority service, and the DCI transmitted later has a high priority, that is, schedules a high-priority service. For instance, the network device transmits the first DCI and then transmits the second DCI and the HARQ feedback codebook carried by the PUCCH format 0 sequence received from the user equipment is “01”, the HARQ feedback bit corresponding to the first DCI is “0” and the HARQ feedback bit corresponding to the second DCI is “1”. For instance, the network device transmits the second DCI and then transmits the first DCI and the HARQ feedback codebook carried by the PUCCH format 0 sequence received from the user equipment is “01”, the HARQ feedback bit corresponding to the second DCI is “0” and the HARQ feedback bit corresponding to the first DCI is “1”.

S10034, on a condition that the number of the HARQ feedback bits is one HARQ feedback bit, it is determined that the HARQ feedback bit included in the HARQ feedback codebook corresponds to higher-priority DCI of the first DCI and the second DCI.

When the network device determines that the number of the HARQ feedback bits is one HARQ feedback bit, it is determined that the HARQ feedback bit included in the HARQ feedback codebook carried by the PUCCH format 0 sequence received corresponds to the higher-priority DCI of the first DCI and the second DCI. For instance, on a condition that the first DCI transmitted by the network device has a high priority, that is, schedules the high-priority service, the second DCI transmitted by the network device has a low priority, that is, schedules the low-priority service, and the HARQ feedback codebook carried by the PUCCH format 0 sequence received from the user equipment is “1”, the network device determines that the HARQ feedback bit “1” carried by the PUCCH format 0 sequence received is the HARQ feedback bit of the high-priority service corresponding to the first DCI. For instance, on a condition that the first DCI transmitted by the network device has a low priority, the second DCI transmitted by the network device has a high priority, and the HARQ feedback codebook carried by the PUCCH format 0 sequence received from the network device is “1”, the HARQ feedback bit “1” carried by the PUCCH format 0 sequence received is the HARQ feedback bit of the high-priority service corresponding to the second DCI.

According to the method for feeding back an HARQ of the example of the disclosure, after receiving the PUCCH format 0 sequence, the network device analyzes the PUCCH format 0 sequence fed back based on the preconfigured mode, so as to determine the number of the HARQ feedback bits included in the HARQ feedback codebook carried by the PUCCH format 0 sequence fed back, and determines the values of the HARQ feedback bits included in the HARQ feedback codebook and the corresponding DCI based on the number of the HARQ feedback bits and the preconfigured mode. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

FIG. 11 is a schematic flow diagram of a method for feeding back an HARQ according to an example of the disclosure. As shown in FIG. 11, the method may be performed by a network device, and includes the following steps:

S1101, a RRC configuration message is transmitted to UE. The RRC configuration message is configured to configure a preconfigured mode for the UE.

In the example, the preconfigured mode may be configured by the network device through RRC signaling. The network device may preconfigure a mode for processing a PUCCH format 0 sequence for the user equipment through the RRC signaling according to actual needs in a case that HARQ feedback has to be multiplexed.

S1102, first DCI and second DCI are transmitted, and a PUCCH sequence fed back by the user equipment is received. The first DCI and the second DCI indicate that a same PUCCH sequence carries an HARQ feedback codebook including a first HARQ feedback bit for the first DCI and a second HARQ feedback bit for the second DCI. The PUCCH sequence fed back is a PUCCH format 0 sequence.

Reference may be made to description of S801-S1001 and related details for detailed description of S1102 and related details, which will not be repeated here.

S1103, the PUCCH sequence fed back is analyzed based on a preconfigured mode, so as to determine a number of HARQ feedback bits included in the HARQ feedback codebook.

Reference may be made to description of S802-S1002 and related details for detailed description of S1103 and related details, which will not be repeated here.

S1104, values of the HARQ feedback bits included in the HARQ feedback codebook and DCI corresponding to the HARQ feedback bits included in the HARQ feedback codebook are determined based on the preconfigured mode and the number of the HARQ feedback bits.

Reference may be made to description of S803-S1003 and related details for detailed description of S1104 and related details, which will not be repeated here.

According to the method for feeding back an HARQ of the example of the disclosure, after receiving the PUCCH format 0 sequence, the network device analyzes the PUCCH format 0 sequence fed back based on the preconfigured mode, so as to determine the number of the HARQ feedback bits included in the HARQ feedback codebook carried by the PUCCH format 0 sequence fed back, and determines the values of the HARQ feedback bits included in the HARQ feedback codebook and the corresponding DCI based on the number of the HARQ feedback bits and the preconfigured mode. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

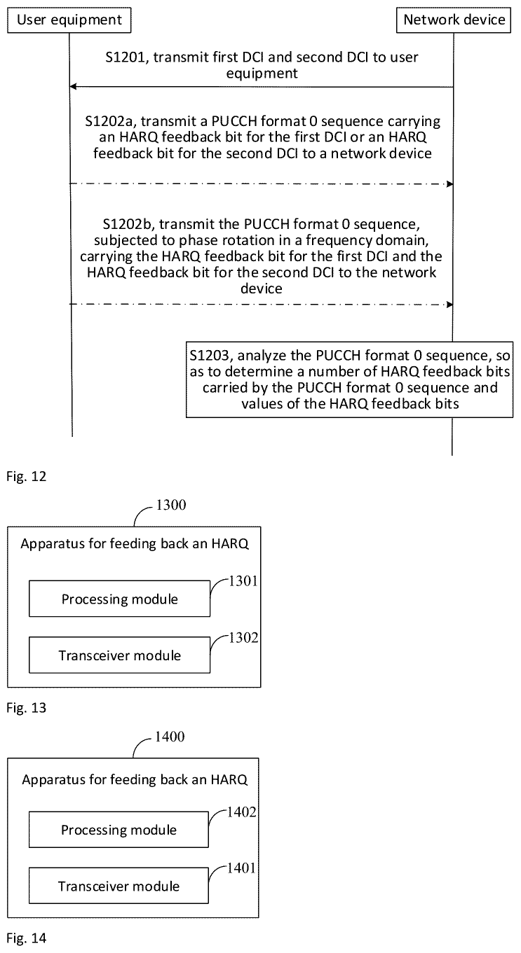

FIG. 12 is a schematic flow diagram of a method for feeding back an HARQ according to an example of the disclosure. As shown in FIG. 12, the method may be performed by user equipment and a network device, and includes the following steps:

S1201, the network device transmits first DCI and second DCI to the user equipment. The first DCI and the second DCI schedule downlink services having different priorities, and instruct the user equipment to multiplex HARQ feedback on a same physical resource.

S1202, the user equipment conducts HARQ feedback based on the DCI received. Specifically, S1202 may include S1202a or S1202b. As shown in the figure, a dotted line indicates that S1202a or S1202b is performed.

S1202a, the user equipment only receives the first DCI or the second DCI, and transmits a PUCCH format 0 sequence carrying an HARQ feedback bit for the first DCI or an HARQ feedback bit for the second DCI to the network device.

In this case, DCI is missed at a user equipment side, and the user equipment only detects one of the first DCI and the second DCI. In this way, the user equipment only conducts HARQ feedback on the DCI received, that is, multiplexing of the HARQ feedback is not required. Specifically, on a condition that the user equipment only receives the first DCI, the user equipment transmits the PUCCH format 0 sequence carrying the HARQ feedback bit for the first DCI to the network device. On a condition that the user equipment only receives the second DCI, the user equipment transmits the PUCCH format 0 sequence carrying the HARQ feedback bit for the first DCI to the network device.

S1202b, the user equipment receives the first DCI and the second DCI, conducts phase rotation on the PUCCH format 0 sequence carrying the HARQ feedback codebook in a frequency domain, and transmits the PUCCH format 0 sequence subjected to phase rotation to the network device. The PUCCH format 0 sequence is a PUCCH format 0 sequence carrying the HARQ feedback bit for the first DCI and the HARQ feedback bit for the second DCI.

In this case, DCI is not missed at a user equipment side, and the user equipment detects the first DCI and the second DCI. In this way, a user needs to multiplex the HARQ feedback for the first DCI and the second DCI.

S1203, the network device receives the PUCCH format 0 sequence fed back by the user equipment, and the PUCCH format 0 sequence is analyzed to determine whether the PUCCH format 0 sequence is subjected to phase rotation, such that a number of HARQ feedback bits carried by the PUCCH format 0 sequence and values of the HARQ feedback bits are determined.

In the example, the network device instructs the user equipment to multiplex the HARQ feedback by scheduling the first DCI and the second DCI of downlink services having different priorities, such that the network device determines whether the PUCCH format 0 sequence is subjected to phase rotation through analysis after receiving the PUCCH format 0 sequence fed back by the user equipment, that is, determines whether the user equipment multiplexes the HARQ feedback, and further determines the value of the HARQ feedback bit.

However, on a condition that the network device only transmits one piece of DCI to the user equipment in S1201, the network device does not instruct the user equipment to multiplex the HARQ feedback after receiving the PUCCH format 0 sequence fed back for the DCI by the user. Thus, the network device does not need to determine whether the user equipment multiplexes the HARQ feedback, and may directly determine the value of the HARQ feedback bit according to the prior art.

It should be understood that how the network device analyzes the PUCCH format 0 sequence so as to determine whether the PUCCH format 0 sequence is subjected to phase rotation such that the number of the HARQ feedback bits carried by the PUCCH format 0 sequence and the values of the HARQ feedback bits are determined, and how the user equipment conducts phase rotation and reports a feedback result to the network device, are described in detail in the above examples, which will not be repeated here.

In the example according to the disclosure, the method according to the example of the disclosure is introduced from aspects of a network device and user equipment separately. In order to achieve functions of the method according to the example of the disclosure, the network device and the user equipment may include hardware structures and software modules. The above functions are achieved in a form of a hardware structure, a software module, or a combination of a hardware structure and a software module. One of the above functions may be performed by a hardware structure, a software module, or a combination of a hardware structure and a software module.

Corresponding to the method for feeding back an HARQ according to the above examples, the disclosure further provides the apparatus for feeding back an HARQ. Since the apparatus for feeding back an HARQ according to the example of the disclosure corresponds to the method for feeding back an HARQ according to the above examples, the embodiments of the method for feeding back an HARQ are also applicable to the apparatus for feeding back an HARQ according to the example, which will not be described in detail in the example.

FIG. 13 is a schematic structural diagram of an apparatus 1300 for feeding back an HARQ according to an example of the disclosure.

As shown in FIG. 13, the apparatus 1300 may include a processing module 1301 and a transceiver module 1302.

The processing module 1301 is configured to process, on a condition that it is determined that a same physical uplink control channel (PUCCH) sequence has to carry an HARQ feedback codebook based on first downlink control information (DCI) and second DCI received from a network device, the PUCCH sequence corresponding to a first HARQ feedback bit and a second HARQ feedback bit based on a preconfigured mode. The PUCCH sequence is a PUCCH format 0 sequence. The HARQ feedback codebook includes the first HARQ feedback bit for the first DCI and the second HARQ feedback bit for the second DCI.

The transceiver module 1302 is configured to transmit the processed PUCCH sequence to the network device.

According to the apparatus for feeding back an HARQ of the example of the disclosure, on a condition that it is determined that a same PUCCH format 0 sequence has to carry the first HARQ feedback bit for the first DCI and the second HARQ feedback bit for the second DCI that are transmitted by the network device, user equipment processes the PUCCH format 0 sequence based on the preconfigured mode; and the processed PUCCH format 0 sequence is transmitted to the network device. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

In some examples, the preconfigured mode includes a rotation mode. The processing module 1301 is configured to conduct phase rotation on the PUCCH sequence in a frequency domain.

In some examples, the processing module 1301 is configured to conduct phase rotation on the PUCCH sequence by 45° in a predetermined direction in the frequency domain.

In some examples, the processing module 1301 is configured to conduct, on a condition that the first HARQ feedback bit and the second HARQ feedback bit have a same value, phase rotation on the PUCCH sequence by 15° in the predetermined direction in the frequency domain; and conduct, on a condition that the first HARQ feedback bit and the second HARQ feedback bit have different values, phase rotation on the PUCCH sequence by 75° in a predetermined direction in the frequency domain.

In some examples, on a condition that a priority of the first HARQ feedback bit is higher than that of the second HARQ feedback bit, the predetermined direction is a clockwise direction. On a condition that the priority of the first HARQ feedback bit is lower than that of the second HARQ feedback bit, the predetermined direction is an anticlockwise direction. The first HARQ feedback bit is a first bit in the HARQ feedback codebook, and the second HARQ feedback bit is a second bit in the HARQ feedback codebook.

In some examples, the transceiver module 1302 is further configured to receive a RRC configuration message from the network device. The processing module 1301 is further configured to determine the preconfigured mode based on the RRC configuration message received from the network device.

FIG. 14 is a schematic structural diagram of an apparatus 1400 for feeding back an HARQ according to an example of the disclosure.

As shown in FIG. 14, the apparatus 1400 may include a transceiver module 1401 and a processing module 1402.

The transceiver module 1401 may be configured to transmit first downlink control information (DCI) and second DCI, and receive a physical uplink control channel (PUCCH) sequence fed back by user equipment (UE). The first DCI and the second DCI indicate that a same PUCCH sequence carries an HARQ feedback codebook including a first HARQ feedback bit for the first DCI and a second HARQ feedback bit for the second DCI. The PUCCH sequence fed back is a PUCCH format 0 sequence.

The processing module 1402 may be configured to determine a number of HARQ feedback bits included in the HARQ feedback codebook based on a preconfigured mode; and determine values of the HARQ feedback bits included in the HARQ feedback codebook and DCI corresponding to the HARQ feedback bits included in the HARQ feedback codebook based on the number of the HARQ feedback bits and the preconfigured mode.

According to the apparatus for feeding back an HARQ of the example of the disclosure, after receiving the PUCCH format 0 sequence, the network device analyzes the PUCCH format 0 sequence fed back based on the preconfigured mode, so as to determine the number of the HARQ feedback bits included in the HARQ feedback codebook carried by the PUCCH format 0 sequence fed back, and determines the values of the HARQ feedback bits included in the HARQ feedback codebook and the corresponding DCI based on the number of the HARQ feedback bits and the preconfigured mode. In this way, the network device may determine whether DCI is missed and may determine DCI corresponding to the HARQ feedback bit carried by the PUCCH format 0 sequence received, such that a high-priority HARQ feedback bit can be identified as reliably as possible in a case that the DCI is missed, and no additional resource overhead can be generated.

In some examples, the processing module 1402 is configured to determine a correlation between the PUCCH sequence fed back and a plurality of local PUCCH sequences based on the preconfigured mode, where the plurality of local PUCCH sequences include all possible first local PUCCH sequences corresponding to two HARQ feedback bits and a plurality of second local PUCCH sequences obtained by separately processing the plurality of first local PUCCH sequences based on preconfigured mode, and each local PUCCH sequence is a PUCCH format 0 sequence; determine, based on the correlation, whether the PUCCH sequence fed back is a PUCCH sequence processed by the UE based on the preconfigured mode or a PUCCH sequence not processed by the UE based on the preconfigured mode; determine, on a condition that the PUCCH sequence fed back is the PUCCH sequence processed by the UE based on the preconfigured mode, that the HARQ feedback codebook includes two HARQ feedback bits; and determine, on a condition that the PUCCH sequence fed back is the PUCCH sequence not processed by the UE based on the preconfigured mode, that the HARQ feedback codebook only includes one HARQ feedback bit.

In some examples, the processing module 1402 is configured to determine a correlation between the PUCCH sequence fed back and a plurality of local PUCCH sequences based on the number of the HARQ feedback bits and the preconfigured mode, where on a condition that the number of the HARQ feedback bits is two HARQ feedback bits, the plurality of local PUCCH sequences include a plurality of second local PUCCH sequences obtained by separately processing all possible first local PUCCH sequences corresponding to the two HARQ feedback bits based on the preconfigured mode; and on a condition that the number of the HARQ feedback bits is one HARQ feedback bit, the plurality of local PUCCH sequences include all possible third local PUCCH sequences corresponding to the one HARQ feedback bit, and each local PUCCH sequence is a PUCCH format 0 sequence; determine the value of the HARQ feedback bit included in the HARQ feedback codebook based on the correlation; determine, on a condition that the number of the HARQ feedback bits is two HARQ feedback bits, that the HARQ feedback bits included in the HARQ feedback codebook correspond to the first DCI and the second DCI respectively; and determine, on a condition that the number of the HARQ feedback bits is one HARQ feedback bit, that the HARQ feedback bit included in the HARQ feedback codebook corresponds to higher-priority DCI of the first DCI and the second DCI.

In some examples, the preconfigured mode includes a rotation mode. The rotation mode instructs the UE to conduct phase rotation on the PUCCH sequence carrying the HARQ feedback codebook in a frequency domain.

In some examples, the rotation mode includes a first rotation mode. The first rotation mode instructs the UE to conduct phase rotation on the PUCCH sequence carrying the HARQ feedback codebook by 45° in a predetermined direction in the frequency domain.

In some examples, the rotation mode includes a second rotation mode. The second rotation mode instructs the UE to conduct, on a condition that the first HARQ feedback bit and the second HARQ feedback bit have a same value, phase rotation on the PUCCH sequence carrying the HARQ feedback codebook by 15° in a predetermined direction in the frequency domain, and to conduct, on a condition that the first HARQ feedback bit and the second HARQ feedback bit have different values, phase rotation on the PUCCH sequence carrying the HARQ feedback codebook by 75° in a predetermined direction in the frequency domain.

In some examples, on a condition that a priority of the first HARQ feedback bit is higher than that of the second HARQ feedback bit, the predetermined direction is a clockwise direction. On a condition that the priority of the first HARQ feedback bit is lower than that of the second HARQ feedback bit, the predetermined direction is an anticlockwise direction. The first HARQ feedback bit is a first bit in the HARQ feedback codebook, and the second HARQ feedback bit is a second bit in the HARQ feedback codebook.

In some examples, the transceiver module 1401 is further configured to transmit a radio resource control (RRC) configuration message to the UE. The RRC configuration message is configured to configure the preconfigured mode for the UE.

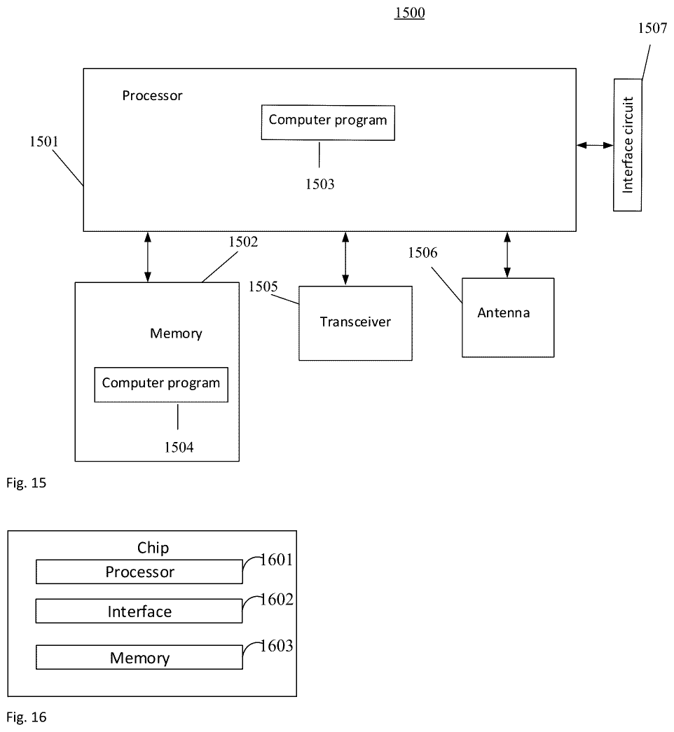

With reference to FIG. 15, FIG. 15 is a schematic structural diagram of a communication apparatus 1500 according to an example of the disclosure. The communication apparatus 1500 may be a network device, user equipment, a chip, a chip system, or a processor that enables the network device to implement the above method, or a chip, a chip system, or a processor that enables the user equipment to implement the above method. The apparatus may be configured to implement the method described in the above method examples. Reference may be made to the description in the above method examples for details.

The communication apparatus 1500 may include one or more processors 1501. The processor 1501 may be a general-purpose processor, a special-purpose processor, etc. For instance, the processor may be a baseband processor or a central processing unit. The baseband processor may be configured to process a communication protocol and communication data. The central processing unit may be configured to control the communication apparatus (for instance, a base station, a baseband chip, a terminal device, a terminal device chip, a DU, or a CU), execute a computer program, and process data of the computer program.

Optionally, the communication apparatus 1500 may further include one or more memories 1502. The memory may store a computer program 1504. The processor 1501 executes the computer program 1504, such that the communication apparatus 1500 executes the method described in the above method example. Optionally, the memory 1502 may further store data. The communication apparatus 1500 and the memory 1502 may be arranged separately or integrated with each other.

Optionally, the communication apparatus 1500 may further include a transceiver 1505 and an antenna 1506. The transceiver 1505 may be referred to as a transmission-reception unit, a transmission-reception machine, a transmission-reception circuit, etc., and is configured to achieve a transceiving function. The transceiver 1505 may include a receiver and a transmitter. The receiver may be referred to as a reception machine or a reception circuit, and is configured to achieve a reception function. The transmitter may be referred to as a transmission machine or a transmission circuit, and is configured to achieve a transmission function.

Optionally, the communication apparatus 1500 may further include one or more interface circuits 1507. The interface circuit 1507 is configured to receive a code instruction and transmit the code instruction to the processor 1501. The processor 1501 runs the code instruction, such that the communication apparatus 1500 executes the method described in the above method example.

If the communication apparatus 1500 is the user equipment, the processor 1501 is configured to execute S301 in FIG. 3, S401 including S4011 in FIG. 4, S501 including S5011 and S50111-S50112 in FIG. 5, and S701-S702 in FIG. 7; and the transceiver 1505 is configured to execute S302 in FIG. 3, S402 in FIG. 4, S502 in FIG. 5, and S703 in FIG. 7.

If the communication apparatus 1500 is the network device, the processor 1501 is configured to execute S802-S803 in FIG. 8, S902-S903 including S9021-S9024 in FIG. 9, S1002-S1003 including S10031-S10034 in FIG. 10, and S1103-S1104 in FIG. 11; and the transceiver 1505 is configured to execute S801 in FIG. 8, S901 in FIG. 9, S1001 in FIG. 10, and S1101-S1102 in FIG. 11.

In an embodiment, the processor 1501 may include the transceiver configured to achieve reception and transmission functions. For instance, the transceiver may be a transmission-reception circuit, an interface, or an interface circuit. The transmission-reception circuit, interface or interface circuit configured to achieve the reception and transmission functions may be separated or integrated. The transmission-reception circuit, interface or interface circuit may be configured to read and write codes/data. Alternatively, the transmission-reception circuit, interface or interface circuit may be configured to transmit or transfer a signal.

In an embodiment, the processor 1501 may store a computer program 1503. The computer program 1503 runs on the processor 1501, such that the communication apparatus 1500 may execute the method described in the above method example. The computer program 1503 may be cured in the processor 1501. In this case, the processor 1501 may be implemented by hardware.

In an embodiment, the communication apparatus 1500 may include a circuit. The circuit may achieve the transmission or reception or communication function in the above method example. The processor and transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be manufactured by means of various IC process technologies, such as a complementary metal oxide semiconductor (CMOS), an N-metal oxide semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus according to the above examples may be the network device or the user equipment, which does not limit the scope of the communication apparatus according to the disclosure. A structure of the communication apparatus may not be limited by FIG. 15. The communication apparatus may be an independent device or may be part of a large device. For instance, the communication apparatus may be:
(1) an independent integrated circuit (IC), or a chip, or a chip system, or a subsystem;
(2) a set having one or more ICs, where the IC set may also include a storage component configured to store data and a computer program;
(3) an ASIC, for instance, a modem;
(4) a module that may be embedded in other devices;
(5) a reception machine, a terminal device, an intelligent terminal device, a cellular phone, a radio device, a handset, a mobile unit, a vehicle-mounted device, a network device, a cloud device, an artificial intelligence device, etc.; and
(6) others, etc.

In a case that the communication apparatus may be a chip or a chip system, reference may be made to a schematic structural diagram of the chip shown in FIG. 16. The chip shown in FIG. 16 includes a processor 1601 and an interface 1602. The number of processors 1601 may be one or more. The number of interfaces 1602 may be greater than one.

In a case that the chip is configured to achieve the functions of the user equipment in the example of the disclosure, the processor 1601 is configured to execute S301 in FIG. 3, S401 including S4011 in FIG. 4, S501 including S5011 and S50111-S50112 in FIG. 5, and S701-S702 in FIG. 7; and the interface 1602 is configured to execute S302 in FIG. 3, S402 in FIG. 4, S502 in FIG. 5, and S703 in FIG. 7.

In a case that the chip is configured to achieve the functions of the network device in the example of the disclosure, the processor 1601 is configured to execute S802-S803 in FIG. 8, S902-S903 including S9021-S9024 in FIG. 9, S1002-S1003 including S10031-S10034 in FIG. 10, and S1103-S1104 in FIG. 11; and the transceiver 1602 is configured to execute S801 in FIG. 8, S901 in FIG. 9, S1001 in FIG. 10, and S1101-S1102 in FIG. 11.

Optionally, the chip further includes a memory 1603. The memory 1603 is configured to store a computer program and data that are necessary.

Those skilled in the art may further understand that various illustrative logical blocks and steps listed in the examples of the disclosure may be implemented by electronic hardware, computer software, or a combination of both. Whether the function is achieved by hardware or software depends on specific applications and design requirements of an entire system. Those skilled in the art may use different methods to achieve the above functions for each particular application, but such implementation is not considered to fall beyond the protection scope of the examples of the disclosure.

An example of the disclosure further provides a determination system for cell configuration. The system includes the communication apparatus as the user equipment in the example of FIG. 13 and the communication apparatus as the network device in the example of FIG. 14. Alternatively, the system includes the communication apparatus as the user equipment and the communication apparatus as the network device in the example of FIG. 15.

The disclosure further provides a readable storage medium. The readable storage medium stores an instruction. The instruction when executed by a computer, causes the computer to achieve the functions of any one of the above method examples.

The disclosure further provides a computer program product. The computer program product when executed by a computer, causes the computer to achieve the functions of any one of the above method examples.

The above examples may be partially or completely achieved by software, hardware, firmware or any combination of them. During implementation with software, the examples may be partially or completely implemented in the form of a computer program product. The computer program product includes one or more computer programs. When the computer program is loaded and executed on the computer, flows or functions according to the examples of the disclosure are partially or completely generated. The computer may be a general-purpose computer, a special-purpose computer, a computer network, or other programmable apparatuses. The computer program may be stored in a computer-readable storage medium or transmitted from a computer-readable storage medium to another computer-readable storage medium. For instance, the computer program may be transmitted from a website, a computer, a server or a data center to another website, another computer, another server or another data center in a wired way (a coaxial cable, an optical fiber, or a digital subscriber line (DSL)) or a wireless way (infrared waves, radio, or microwaves). The computer-readable storage medium may be any available medium that may be accessed by the computer or a data storage device such as a server and a data center that includes one or more available media integrated. The available medium may be a magnetic medium (for instance, a floppy disk, a hard disk, or a magnetic tape), an optical medium (for instance, a high-density digital video disc (DVD)), a semiconductor medium (for instance, a solid state disk (SSD)), etc.

Those of ordinary skill in the art may understand that numerical symbols such as “first” and “second” involved in the disclosure are only for convenience of description, instead of limiting the scope of the examples of the disclosure, and further indicate a sequence.

“At least one” in the disclosure may also be described as “one or more”, and “a plurality of” may indicate two, three, four or more, which are not limited by the disclosure. In the example of the disclosure, for a technical feature, technical features in the technical feature are distinguished by “first”, “second”, “third”, “A”, “B”, “C”, “D”, etc. The technical features described by the “first”, “second”, “third”, “A”, “B”, “C” and “D” are not in order of succession or order of size.

As used here, the terms “machine-readable medium” and “computer-readable medium” refer to any computer program product, device, and/or apparatus (for instance, a magnetic disk, an optical disk, a memory, a programmable logic device (PLD)) configured to provide a machine instruction and/or data for a programmable processor, including a machine-readable medium receiving a machine instruction as a machine-readable signal. The term “machine-readable signal” refers to any signal configured to provide a machine instruction and/or data for a programmable processor.

The systems and technologies described here may be implemented in a computation system (for instance, as a data server) including a background component, or a computation system (for instance, an application server) including a middleware component, or a computation system (for instance, a user computer having a graphical user interface or a web browser through which a user may interact with the embodiments of the systems and technologies described here) including a front-end component, or a computation system including any combination of such background components, middleware components, or front-end components. The components of the system may be connected to each other through digital data communication (for example, a communication network) in any form or medium. Instances of the communication network include: a local area network (LAN), a wide area network (WAN), and the Internet.

A computer system may include a client and a server. The client and the server are generally far away from each other and typically interact with each other through a communication network. A relation between the client and the server is generated by computer programs operating on corresponding computers and having a client-server relation with each other.

It should be understood that the steps may be reordered, added or deleted by using the various flows illustrated above. For instance, the steps described in the disclosure may be executed in parallel, in order, or in a different order, provided that the desired result of the technical solution in the disclosure may be achieved, which is not limited here.

In addition, it should be understood that various examples described in the disclosure may be implemented separately or in combination with other examples under permission of the solution.

Those of ordinary skill in the art may understand that the units and algorithm steps of the instances described in connection with the examples disclosed here may be implemented in electronic hardware, or a combination of computer software and electronic hardware. Whether the functions are executed in hardware or software depends on specific application and design constraints of the technical solution. Professionals may use different methods to implement the described functions for each specific application, but such implementation shall not be considered to fall beyond the scope of the disclosure.

Those skilled in the art may clearly understand that, for the convenience and conciseness of description, reference may be made to a corresponding process in the above method example for a specific operation process of the system, apparatus and unit described above, which will not be repeated here.

What are described above are merely specific embodiments of the disclosure, and are not intended to limit the protection scope of the disclosure. Any changes or substitutions that may be easily made by those skilled in the art within the technical scope disclosed in the disclosure shall fall within the protection scope of the disclosure. Thus, the protection scope of the disclosure should be subject to the protection scope of the claims.

1. A method for feeding back a hybrid automatic repeat request (HARQ), the method performed by user equipment (UE) and comprising:
processing, on a condition that it is determined that a same physical uplink control channel (PUCCH) sequence has to carry an HARQ feedback codebook based on first downlink control information (DCI) and second DCI received from a network device, the PUCCH sequence carrying the HARQ feedback codebook based on a preconfigured mode, wherein the PUCCH sequence is a PUCCH format 0 sequence, and the HARQ feedback codebook comprises a first HARQ feedback bit for the first DCI and a second HARQ feedback bit for the second DCI; and
transmitting a processed PUCCH sequence to the network device.

2. The method according to claim 1, wherein the preconfigured mode comprises a rotation mode, and the processing the PUCCH sequence carrying the HARQ feedback codebook based on a preconfigured mode comprises:
conducting phase rotation on the PUCCH sequence in a frequency domain.

3. The method according to claim 2, wherein the conducting phase rotation on the PUCCH sequence in a frequency domain comprises:
conducting phase rotation on the PUCCH sequence by 45° in a predetermined direction in the frequency domain.

4. The method according to claim 2, wherein the conducting phase rotation on the PUCCH sequence in a frequency domain comprises at least one of:
conducting, on a condition that the first HARQ feedback bit and the second HARQ feedback bit have a same value, phase rotation on the PUCCH sequence by 15° in a predetermined direction in the frequency domain; or
conducting, on a condition that the first HARQ feedback bit and the second HARQ feedback bit have different values, phase rotation on the PUCCH sequence by 75° in a predetermined direction in the frequency domain.

5. The method according to claim 3, wherein
on a condition that a priority of the first HARQ feedback bit is higher than a priority of the second HARQ feedback bit, the predetermined direction is a clockwise direction; and
on a condition that a priority of the first HARQ feedback bit is lower than a priority of the second HARQ feedback bit, the predetermined direction is an anticlockwise direction, wherein
the first HARQ feedback bit is a first bit in the HARQ feedback codebook, and the second HARQ feedback bit is a second bit in the HARQ feedback codebook.

6. The method according to claim 1, further comprising:
determining the preconfigured mode based on a radio resource control (RRC) configuration message received from the network device.

7. A method for feeding back a hybrid automatic repeat request (HARQ), the method performed by a network device and comprising:
transmitting first downlink control information (DCI) and second DCI, and receiving a physical uplink control channel (PUCCH) sequence fed back by user equipment (UE), wherein the first DCI and the second DCI indicate that a same PUCCH sequence carries an HARQ feedback codebook comprising a first HARQ feedback bit for the first DCI and a second HARQ feedback bit for the second DCI, and the PUCCH sequence fed back is a PUCCH format 0 sequence;
determining a number of HARQ feedback bits comprised in the HARQ feedback codebook based on a preconfigured mode; and
determining values of the HARQ feedback bits comprised in the HARQ feedback codebook and DCI corresponding to the HARQ feedback bits comprised in the HARQ feedback codebook based on the number of the HARQ feedback bits and the preconfigured mode.

8. The method according to claim 7, wherein the determining a number of HARQ feedback bits comprised in the HARQ feedback codebook based on a preconfigured mode comprises:
determining a correlation between the PUCCH sequence fed back and a plurality of local PUCCH sequences based on the preconfigured mode, wherein the plurality of local PUCCH sequences comprise all possible first local PUCCH sequences corresponding to two HARQ feedback bits and a plurality of second local PUCCH sequences obtained by separately processing the plurality of first local PUCCH sequences based on the preconfigured mode, and each local PUCCH sequence is a PUCCH format 0 sequence;
determining, based on the correlation, whether the PUCCH sequence fed back is a PUCCH sequence processed by the UE based on the preconfigured mode or a PUCCH sequence not processed by the UE based on the preconfigured mode;
determining, on a condition that the PUCCH sequence fed back is the PUCCH sequence processed by the UE based on the preconfigured mode, that the HARQ feedback codebook comprises two HARQ feedback bits; and
determining, on a condition that the PUCCH sequence fed back is the PUCCH sequence not processed by the UE based on the preconfigured mode, that the HARQ feedback codebook only comprises one HARQ feedback bit.

9. The method according to claim 7, wherein the determining values of the HARQ feedback bits comprised in the HARQ feedback codebook and DCI corresponding to the HARQ feedback bits comprised in the HARQ feedback codebook based on the number of the HARQ feedback bits and the preconfigured mode comprises:
determining a correlation between the PUCCH sequence fed back and a plurality of local PUCCH sequences based on the number of the HARQ feedback bits and the preconfigured mode, wherein on a condition that the number of the HARQ feedback bits is two HARQ feedback bits, the plurality of local PUCCH sequences comprise a plurality of second local PUCCH sequences obtained by separately processing all possible first local PUCCH sequences corresponding to the two HARQ feedback bits based on the preconfigured mode; and on a condition that the number of the HARQ feedback bits is one HARQ feedback bit, the plurality of local PUCCH sequences comprise all possible third local PUCCH sequences corresponding to the one HARQ feedback bit, and each local PUCCH sequence is a PUCCH format 0 sequence;
determining the value of the HARQ feedback bit comprised in the HARQ feedback codebook based on the correlation;
determining, on a condition that the number of the HARQ feedback bits is two HARQ feedback bits, that the HARQ feedback bits comprised in the HARQ feedback codebook correspond to the first DCI and the second DCI respectively; and
determining, on a condition that the number of the HARQ feedback bits is one HARQ feedback bit, that the HARQ feedback bit comprised in the HARQ feedback codebook corresponds to higher-priority DCI of the first DCI and the second DCI.

10. The method according to claim 7, wherein the preconfigured mode comprises a rotation mode, and the rotation mode instructs the UE to conduct phase rotation on the PUCCH sequence carrying the HARQ feedback codebook in a frequency domain.

11. The method according to claim 10, wherein the rotation mode comprises a first rotation mode, and the first rotation mode instructs the UE to conduct phase rotation on the PUCCH sequence carrying the HARQ feedback codebook by 45° in a predetermined direction in the frequency domain.

12. The method according to claim 10, wherein the rotation mode comprises a second rotation mode, and the second rotation mode instructs the UE to conduct, on a condition that the first HARQ feedback bit and the second HARQ feedback bit have a same value, phase rotation on the PUCCH sequence carrying the HARQ feedback codebook by 15° in a predetermined direction in the frequency domain, and to conduct, on a condition that the first HARQ feedback bit and the second HARQ feedback bit have different values, phase rotation on the PUCCH sequence carrying the HARQ feedback codebook by 75° in a predetermined direction in the frequency domain.

13. The method according to claim 11, wherein
on a condition that a priority of the first HARQ feedback bit is higher than a priority of the second HARQ feedback bit, the predetermined direction is a clockwise direction; and
on a condition that a priority of the first HARQ feedback bit is lower than a priority of the second HARQ feedback bit, the predetermined direction is an anticlockwise direction, wherein
the first HARQ feedback bit is a first bit in the HARQ feedback codebook, and the second HARQ feedback bit is a second bit in the HARQ feedback codebook.

14. The method according to claim 7, further comprising:
transmitting a radio resource control (RRC) configuration message to the UE, wherein the RRC configuration message is configured to configure the preconfigured mode for the UE.

15. (canceled)

16. (canceled)

17. A communication device, comprising: a transceiver; a memory; and a processor connected to the transceiver and the memory separately, configured to control the transceiver to transceive radio signals by executing a computer-executable instruction on the memory, and to:
process, on a condition that it is determined that a same physical uplink control channel (PUCCH) sequence has to carry an HARQ feedback codebook based on first downlink control information (DCI) and second DCI received from a network device, the PUCCH sequence carrying the HARQ feedback codebook based on a preconfigured mode, wherein the PUCCH sequence is a PUCCH format 0 sequence, and the HARQ feedback codebook comprises a first HARQ feedback bit for the first DCI and a second HARQ feedback bit for the second DCI; and
transmit a processed PUCCH sequence to the network device.

18. A communication device, comprising: a transceiver; a memory; and a processor connected to the transceiver and the memory separately, configured to control the transceiver to transceive radio signals by executing a computer-executable instruction on the memory, and capable of implementing the method according to claim 7.

19. A non-transitory computer storage medium, storing a computer-executable instruction, wherein the computer-executable instruction when executed by a processor, causes the processor to implement the method according to claim 1.

20. A non-transitory computer storage medium, storing a computer-executable instruction, wherein the computer-executable instruction when executed by a processor, causes the processor to implement the method according to claim 7.

21. The method according to claim 4, wherein
on a condition that a priority of the first HARQ feedback bit is higher than a priority of the second HARQ feedback bit, the predetermined direction is a clockwise direction; and
on a condition that a priority of the first HARQ feedback bit is lower than a priority of the second HARQ feedback bit, the predetermined direction is an anticlockwise direction, wherein
the first HARQ feedback bit is a first bit in the HARQ feedback codebook, and the second HARQ feedback bit is a second bit in the HARQ feedback codebook.

22. The method according to claim 12, wherein
on a condition that a priority of the first HARQ feedback bit is higher than a priority of the second HARQ feedback bit, the predetermined direction is a clockwise direction; and
on a condition that a priority of the first HARQ feedback bit is lower than a priority of the second HARQ feedback bit, the predetermined direction is an anticlockwise direction, wherein
the first HARQ feedback bit is a first bit in the HARQ feedback codebook, and the second HARQ feedback bit is a second bit in the HARQ feedback codebook.
